(19) United States
(12) Patent Application Publication
(10) Pub. No.: US 2014/0033774 A1
(43) Pub. Date: Feb. 6, 2014

(54) ANTI-THEFT SYSTEM AND METHOD FOR FUEL OR OTHER CARGO IN MOBILE STORAGE CONTAINERS

(71) Applicants: Kevin OFCHUS, Atlanta, GA (US); Randall Todd Cline, Granbury, TX (US)

(72) Inventors: Kevin OFCHUS, Atlanta, GA (US); Randall Todd Cline, Granbury, TX (US)

(21) Appl. No.: 13/838,230

(22) Filed: Mar. 15, 2013

Related U.S. Application Data
(60) Provisional application No. 61/679,812, filed on Aug. 6, 2012.

(51) Int. Cl. G07C 9/00

(52) U.S. Cl. CPC G07C 9/00571
USPC 70/264

(57) ABSTRACT

An anti-theft system and method prevents access to and theft of fuel or another material in a container such as a tanker or intermodal container with upload and/or download assemblies. The anti-theft system includes a respective lock for each upload and download assembly, at least one control unit that operates the locks, and a computer program that operates the control unit. The computer program is operated by a user using a workstation to enter commands for the computer program to send signals via a communications network to the control unit to lock and unlock the locks. In a typical embodiment, the locks are provided by electromagnetic locks with an electromagnet base and an armature plate lock, and a satellite network is used for communications in remote or hostile areas.

### CROSS-REFERENCE TO RELATED APPLICATION

This application claims the priority benefit of U.S. Provisional Patent Application No. 61/679,812 filed Aug. 6, 2012, which is hereby incorporated herein by reference.

### TECHNICAL FIELD

The present invention relates generally to mobile storage containers such as fuel tankers, and particularly to anti-theft systems for the fuel or other cargo carried by such mobile storage containers.

### BACKGROUND

Mobile fuel containers such as fuel tankers pulled by tractor trucks carry such large volumes of fuel that their payload is very valuable. Because of this, fuel tanker trucks transporting loads of fuel, especially in hostile environments such as war zones, are common targets for theft. Fuel thefts in such high-threat environments have collectively resulted in substantial losses by the U.S. government. For example, one recent estimate placed these government losses at about 28% of all fuel transported by fuel tanker trucks in one particular war zone. In addition, preventing the theft of high-value loads of other materials and objects (e.g., certain fluids and electronics) from mobile storage containers (e.g., tankers and intermodal shipping/trucking dry containers such as Conex and MilVan containers) is an ongoing problem.

Accordingly, it can be seen that there exists a need for a way to prevent theft of fuel and other cargo during transportation in mobile storage containers such as tanker trucks and intermodal shipping/trucking containers. It is to the provision of solutions to this and other problems that the present invention is primarily directed.

### SUMMARY

Generally described, the present invention relates to anti-theft systems and methods for preventing access to and theft of fuel or other cargo in containers such as tankers or intermodal shipping/trucking dry containers with upload and/or download assemblies. The anti-theft systems include a respective lock for each upload and download assembly, at least one control unit that operates the locks, and a computer program that operates the control unit. The computer program is operated by a user using a workstation to enter commands for the computer program to send signals via a communications network to the control unit to lock and unlock the locks. In addition, the computer program of typical embodiments is also operable by the user to track the location of the tankers and generate reports on the tankers. Furthermore, for some applications a satellite network is used for communications in remote or hostile areas beyond the reliable coverage range of the communications network.

In typical embodiments, the locks are provided by electromagnetic locks with an electromagnet base and an armature plate lock. For example, in embodiments adapted for use with tankers, the upload lock can include a locking arm extending from the armature plate lock to block opening an upload hatch lid of the tanker. And for the download lock on the tanker, the electromagnet base can be mounted inside a box containing download pipes and the armature plate lock mounted to a lid for the box. Similarly, in embodiments adapted for use with intermodal shipping/trucking dry containers with two rear doors cooperatively forming both the upload assembly and the download assembly (the stored/transported items are uploaded and downloaded through the same two doors), one or more of the electromagnet bases can be suspended from the control unit and aligned with one or more armature plate locks mounted to the container doors.

The specific techniques and structures employed to improve over the drawbacks of the prior devices and accomplish the advantages described herein will become apparent from the following detailed description of example embodiments and the appended drawings and claims.

### BRIEF DESCRIPTION OF THE DRAWINGS

FIG. 1 is a system diagram of an anti-theft system according to a first example embodiment of the present invention, showing the anti-theft system in use with a mobile fuel container.

FIG. 2 is a left side view of the mobile fuel container of FIG. 1, showing an upload lock system and control unit and a download lock system and control unit.

FIG. 3 is a right side view of the upload lock system and a portion of the mobile fuel container of FIG. 2, showing the lock in a locked position securing an upload hatch lid in a closed position.

FIG. 4 shows the lock of FIG. 3 in an unlocked position and the upload hatch lid being pivoted to an open position.

FIG. 5 is a perspective view of the upload lock system of FIG. 4.

FIG. 6 is a right side view of an electromagnet base and an armature plate lock of the upload lock system of FIG. 4.

FIG. 7 is a perspective view of the electromagnet base and the armature plate lock of the upload lock system of FIG. 4.

FIG. 8 is a perspective view of a locking body and arm of the upload lock system of FIG. 3.

FIG. 9 is a perspective partially exploded view of the download lock system and a portion of the download assembly of the mobile fuel container of FIG. 2.

FIG. 10 is a top side view of the download lock system and the portion of the download assembly of FIG. 9, showing the lock in a locked position securing a download box lid in a closed position.

FIG. 11 shows the lock of FIG. 10 in an unlocked position and the download box lid being pivoted to an open position.

FIG. 12 is a rear perspective view of the mobile fuel container, the upload lock system and control unit, and the download lock system of FIG. 2.

FIG. 13 is a perspective view of the control unit of FIG. 12.

FIG. 14 is a schematic diagram of the control unit of FIG. 12.

FIG. 15 is a perspective view of a housing of a control unit according to a first alternative embodiment, showing the housing in an open position.

FIG. 16 is a perspective view of the housing of FIG. 15, showing the housing in a closed position.

FIG. 17 is a perspective view of a lock according to the first alternative embodiment, showing the lock in a locked position.

FIG. 18 is a detail side view of the lock of FIG. 17, showing an adjustment mechanism holding the lock arm in position.

FIG. 19 shows the lock of FIG. 18 with the adjustment mechanism operated to adjust the position of the lock arm.

FIG. 20 is a perspective view of an anti-theft system according to a second example embodiment of the present invention, showing the anti-theft system in use with mobile dry-cargo containers.

FIG. 21 is a side view of portions of the locks and the container of FIG. 20, showing the locks in a locked position.

FIG. 22 shows the container and locks portion of FIG. 21 with the locks in an unlocked position.

FIG. 23 is an exploded perspective view of portion of the control unit and the locks of FIG. 20, showing the modular coupling between therebetween.

FIG. 24 is a top view of the control unit and locks portion of FIG. 23 assembled in the locked position.

FIG. 25 is a cross-sectional view of the control unit and locks portion taken at line 25-25 of FIG. 24.

### DETAILED DESCRIPTION OF EXAMPLE EMBODIMENTS

The present invention relates to anti-theft systems and methods for securing cargo in mobile containers such fuel tankers and dry-goods containers that are pulled by tractor trucks. The anti-theft systems and methods provide for remotely controlled access to the fuel or other goods in the containers to prevent unauthorized persons from accessing the cargo in the containers. In this way, the anti-theft systems and methods provide a preventive measure to ensure controlled access to the cargo in the containers and thereby to deny access to the cargo by unauthorized parties until delivery to an authorized receiving agent. Although the systems and methods are described herein as used for securing fuel in tankers and dry goods in containers (e.g., Conex, MilVan, and other dry heavy shipping intermodal containers) pulled by tractor trucks, persons of ordinary skill in the art will readily understand how to adapt the invention for use in other fields such as for other mobile fuel tankers (e.g., for sea or air transport), non-mobile (stationary) fuel tanks, hatched/valved containers for other fluids (i.e., liquid or gas) or for solid materials of high value (e.g., minerals or metals), or other uses in which it is desired to remotely control access to a container of a cargo,. And although the systems and methods described herein were developed for use with mobile fuel containers in war zones, they can alternatively be used effectively in areas that are not hostile.

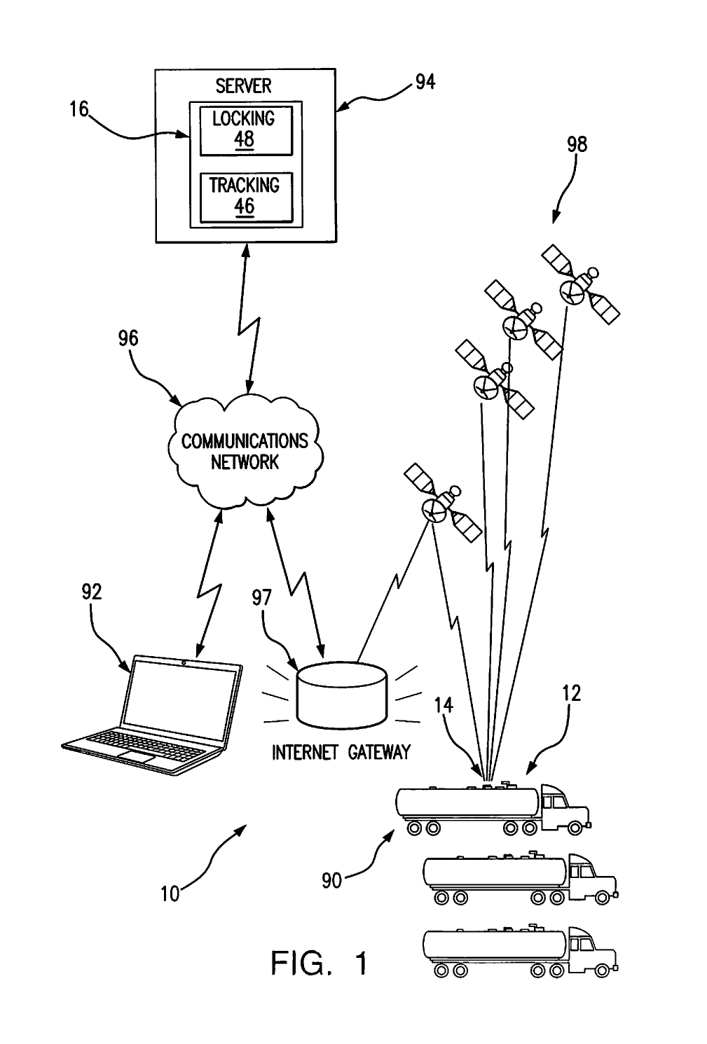

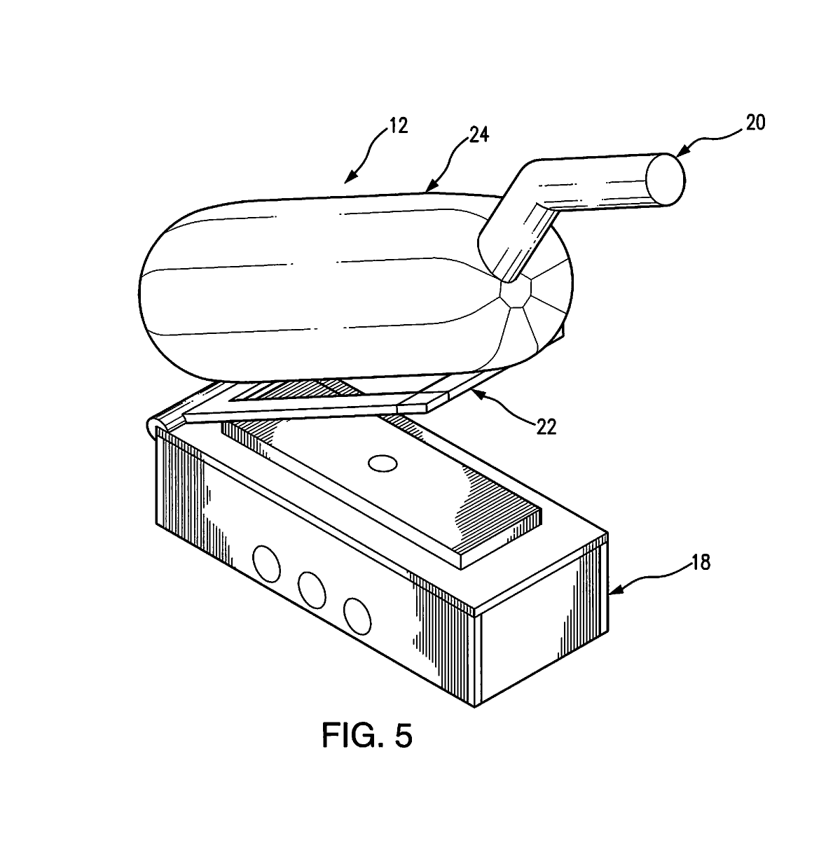

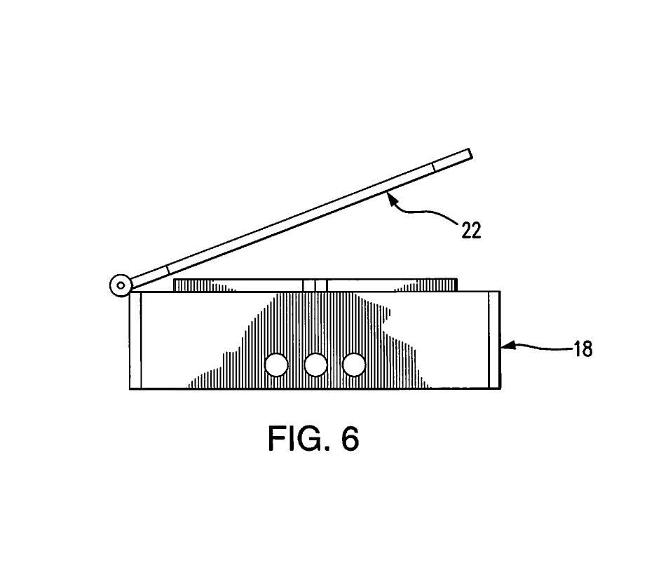

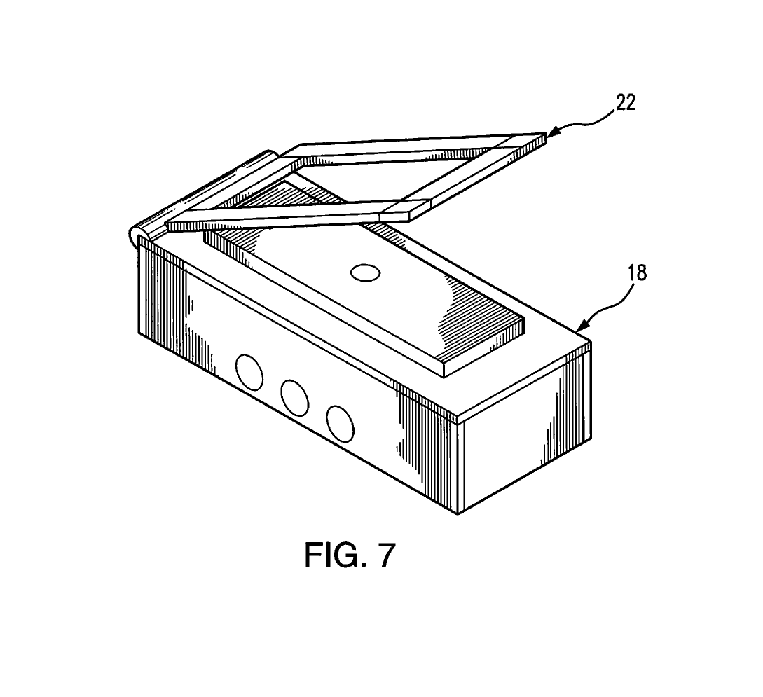

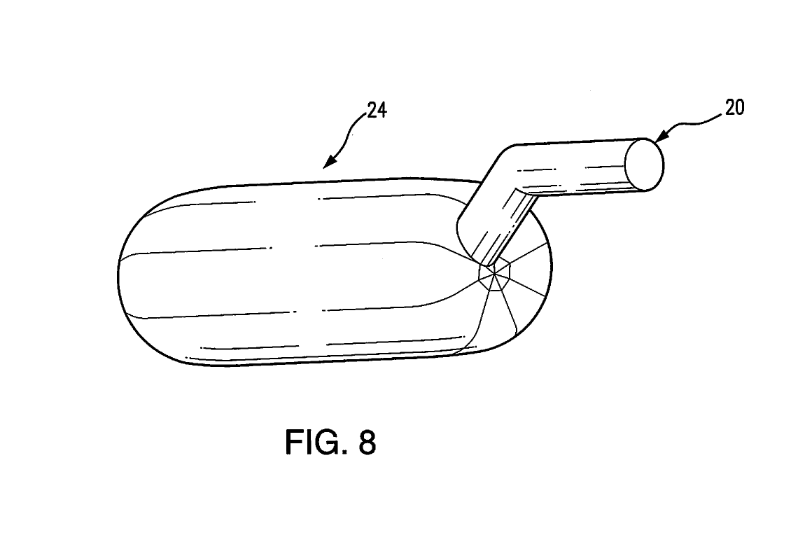

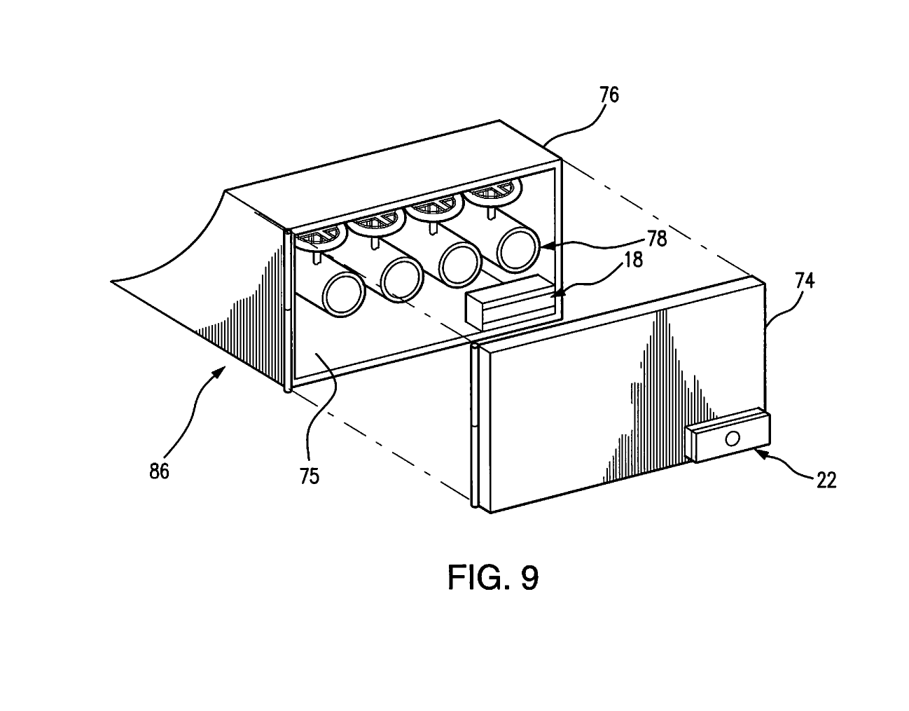

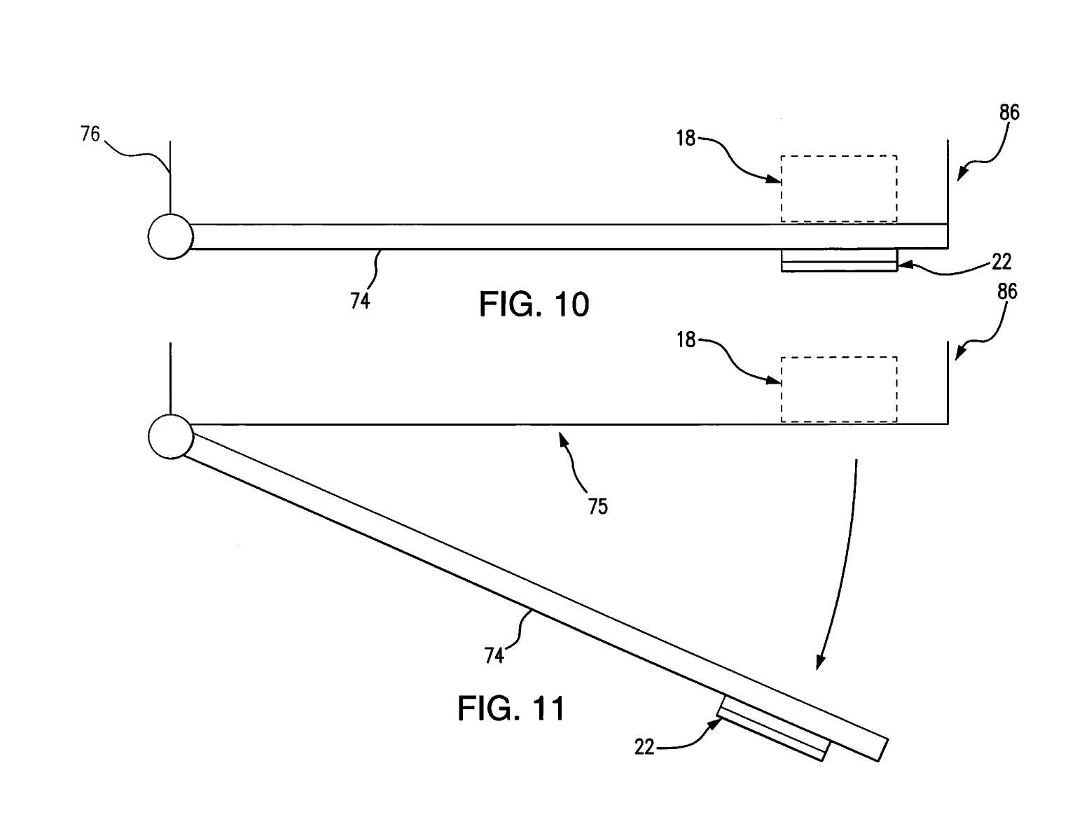

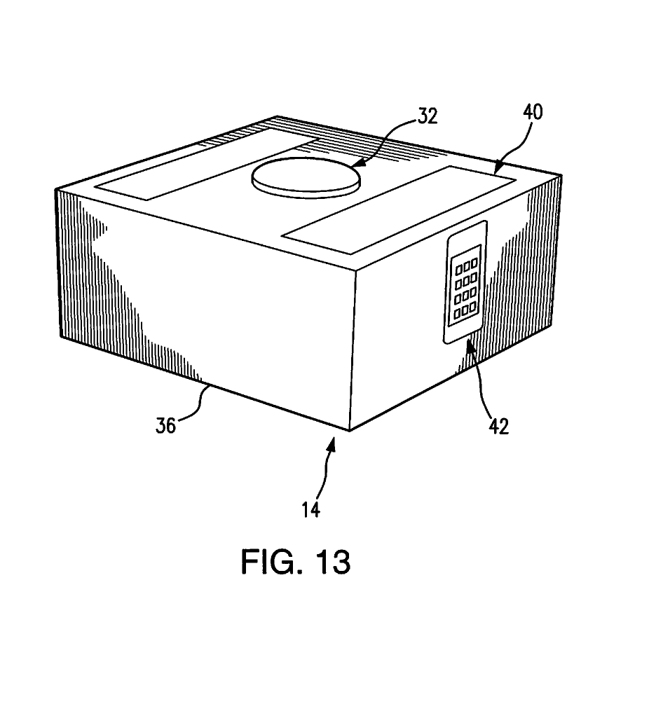

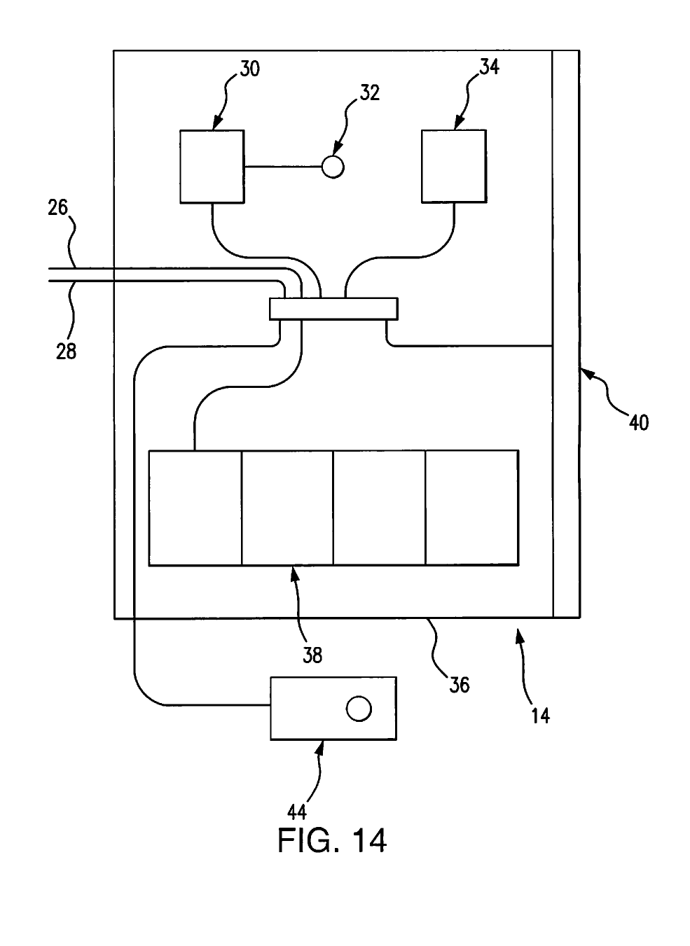

FIGS. 1-14 show an anti-theft system 10 according to a first example embodiment of the invention. The anti-theft system 10 is used in conjunction with a satellite system 98, a communications network 96, a server 94, and at least one workstation 92 to secure fuel in a mobile fuel container 90. The anti-theft system 10 includes one or more lock systems 12, at least one electronic control unit 14, and a computer program 16. The lock systems 12 and the control unit 14 are mounted to the mobile fuel container 90, and the computer program 16 is stored on the server 94. In operation, the workstation 92 is used to access the computer program 16 on the server 94 via the communications network 96, and the server 94 and the control unit 14 communicate via the satellite system 98 and the communications network 96, to operate the lock systems 12. The satellite system 98 allows use of the mobile fuel container 90 and the anti-theft system 10 in areas beyond the coverage of the communications network 96 (e.g., where coverage is non-existent, limited, or not reliable), for example in war zones and remote areas.

Referring with particularity to FIG. 1, the satellite system 98 in the depicted embodiment is the IRIDIUM satellite constellation (Iridium Communications Inc. of McLean, Va.). In other embodiments, another satellite system can be used, such as a GPS satellite system. The communications network 96 in the depicted embodiment is the Internet. In other embodiments, another communications network can be used, such as a cellular telephone network, a WiFi network, a WAN, or a LAN. The server 94 in the depicted embodiment is a conventional computer server (e.g., running Windows 2008) with a processor and a memory storage device storing the computer program 16. The server 94 can be provided by a single computer server or by multiple servers in a bank or cloud configuration. And the workstation 92 in the depicted embodiment is a conventional laptop computer with a processor and a memory storage device. In other embodiments, another workstation can be used, such as a desktop computer, a tablet computer, a smart phone, a dedicated workstation, or another computer device. In the depicted embodiment, the workstation 92 and the server 94 are shown as being remote and communicating via the communications network 96. In other embodiments, the workstation 92 and the server 94 are local to each other, for example in the same facility, with the communications network 96 selected and operably connected accordingly.

In the depicted embodiment, the satellite system 98 communicates with the communications network 96 via a gateway 97 such as a commercial or Department of Defense gateway. In embodiments in which the communications network 96 is the Internet, the gateway 97 is an Internet gateway. In other embodiments, the satellite system 98 is an integral sub-system of the communications network 96 such that the gateway 97 is not needed and is thus excluded from use. And in still other embodiments, particularly those in which the mobile fuel container 90 and the anti-theft system 10 are used in an area covered by the communications network 96, the satellite system 98 and the gateway 97 are not used and are thus excluded from use, and instead the server 94 and the control unit 14 communicate via the communications network only.

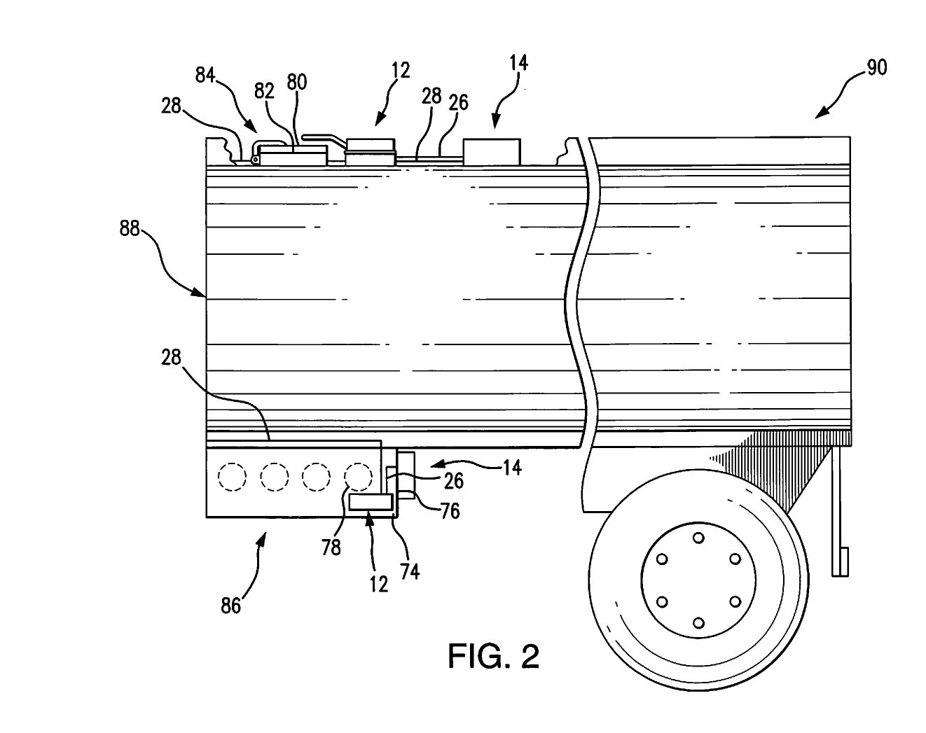

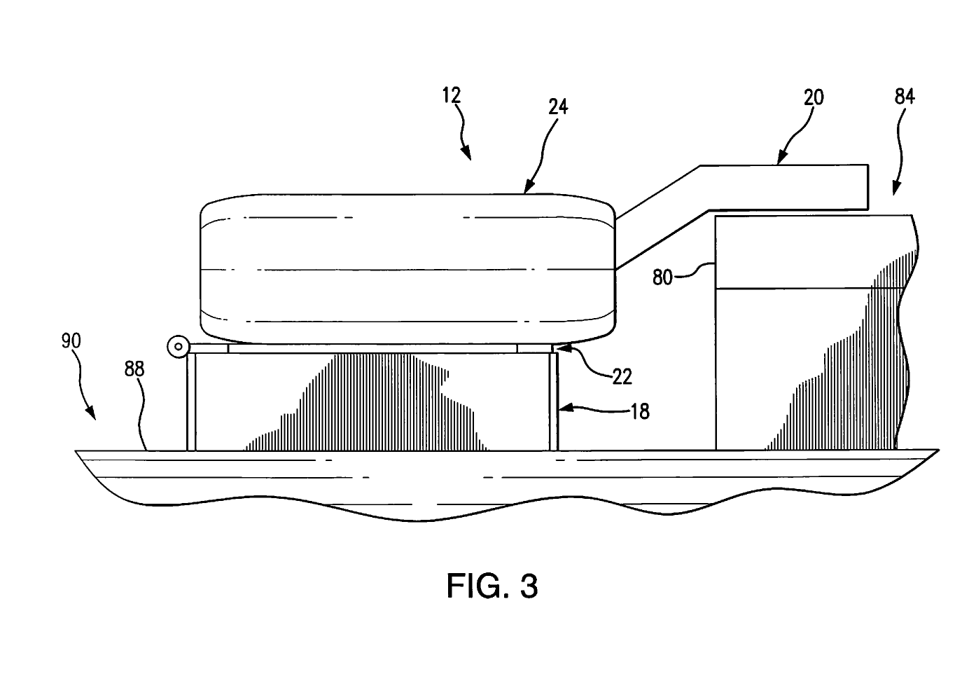

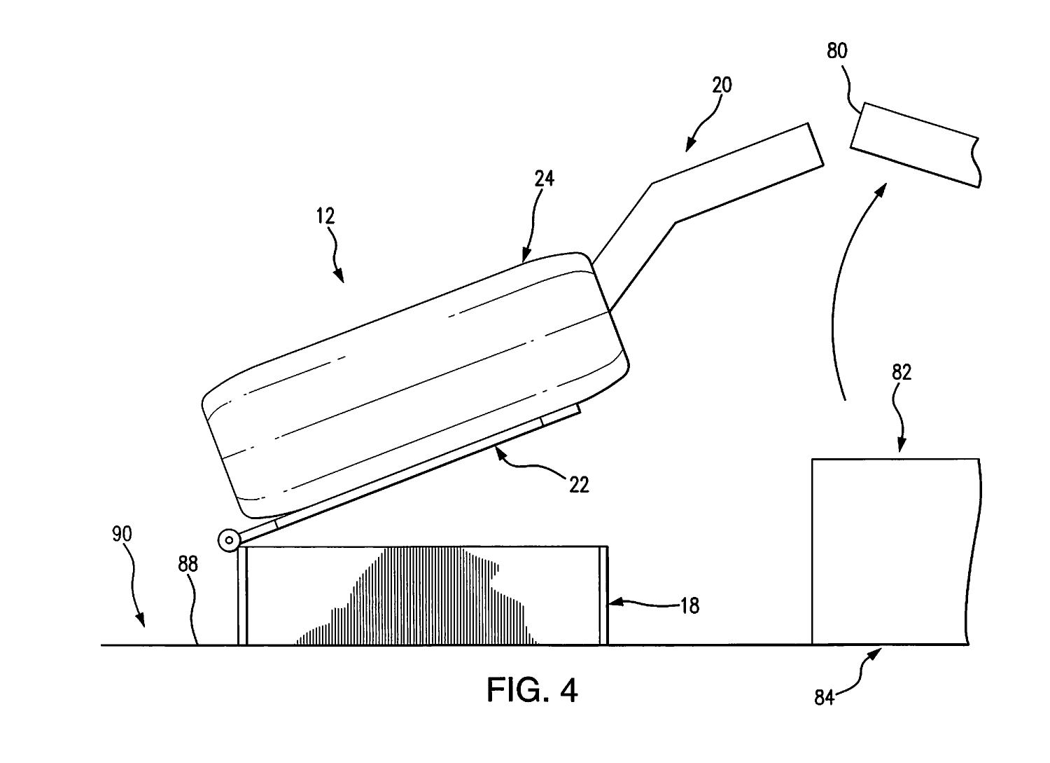

Referring with particularity to FIG. 2, the depicted mobile fuel container 90 is a conventional tanker pulled by a truck (the tanker and the truck can be decoupleable or integral) to transport a fluid fuel such as gasoline, diesel fuel, jet fuel, or oil. As noted herein, the anti-theft system 10 can be readily adapted for use in securing other containers of other materials. The depicted tanker 90 includes a cylindrical tank 88 that is horizontally positioned, at least one download assembly 86, and at least one upload assembly 84. (As used herein, the upload assembly and/or the download assembly are sometimes referred to generally as the “load assembly” to mean either one or both of them.) Each upload assembly 84 typically includes a circular flanged hatch opening 82 and a circular hatch lid 80. The hatch opening 82 is in fluid communication with the interior storage space of the cylindrical tank 88. And the hatch lid 80 pivots between a closed/transport position (FIGS. 2-3) covering the hatch opening 82 for transport and an open/uploading position (FIG. 4) not covering the upload hatch opening 82 for uploading the fuel into the interior storage space of the cylindrical tank 88. And each download assembly 86 typically includes one or more valved pipes 78 enclosed in a box 76 with an opening 75 and a lid 74. The valved pipes 78 are in fluid communication with the interior storage space of the cylindrical tank 88. And the lid 74 pivots between a closed/transport position (FIGS. 2 and 9-10) covering the box opening 75 (i.e., at least blocking access to the valved pipes 78) for transport and an open/downloading position (FIG. 11) not covering the box opening (i.e., allowing access to the valved pipes) for downloading the fuel from the interior storage space of the cylindrical tank 88 through the valved download pipes. Typically, the tanker 90 includes a plurality of upload and download assemblies 84 and 86. For example, in some embodiments the tanker 90 includes eight of the upload assemblies 84 and two of the download assemblies 86, with each download assembly including four valved pipes 78. In other embodiments, the upload and download assemblies are provided by other mechanical assemblies that can be used for uploading and downloading the fuel and that are capable of being locked by the anti-theft systems described herein.

As indicated above, the anti-theft system 10 includes one or more lock systems 12, at least one electronic control unit 14, and a computer program 16. The lock systems 12 selectively secure the fuel in the tanker 90 and are operated by the control units 14, which can be remotely controlled by operating the workstation 92 to access the computer program 16 to communicate with the control units.

In typical embodiments, the control units 14 and the lock systems 12 are separate components, with one control unit operably connected to multiple lock systems on the same tanker 90. For example, in embodiments in which the tanker 90 includes eight of the upload assemblies 84 (each including one hatch upload opening 82) and two of the download assemblies 86 (each including four download valved pipes 78), the system 10 can include one control unit 14 connected to ten lock systems 12 (one for each hatch lid 80 and box lid 74 secured). In alternative embodiments, each lock system 12 has its own dedicated control unit 14, and in some such embodiments the control units and the lock systems are integrated into a single assembly. In typical embodiments, the computer program 16 is stored on the server 94. In alternative embodiments, the computer program 16 is stored on the workstation 92 or elsewhere, and in some embodiments at least one component of the computer program is stored on the workstation or the server 94 and at least one other component of the computer program is stored on a separate server for the satellite system 98. In typical embodiments, multiple workstations 92 (separately or together located) can be used to access one computer program 16 to operate multiple control units 14 on multiple tankers 90, provided that the workstation user(s) have the authority (and enter the corresponding authorization credential(s) into the program) for such operational control. In alternative embodiments, each control unit 14 is operable by only one dedicated workstation or authorized user.

Referring with particularity to FIGS. 3-11, each of the lock systems 12 mounts to the tanker 90 adjacent to or on a respective one of the upload or download assemblies 84 and 86. Each of the lock systems 12 includes a base 18 and a lock member 20 that moves relative to the base member between a locked position (locking the lids 80 and 74 of the upload and download assemblies 84 and 86 in their closed positions) and an unlocked position (permitting the upload and download lids to be moved to their open positions). Because the upload and download assemblies 84 and 86 have structural differences as noted herein, the lock systems 12 can be adapted differently for use with them. Thus the lock systems are referred to herein sometimes individually as the “upload lock system 12a” (FIGS. 2-8) and the “download lock system 12b” (FIGS. 2 and 9-11), and at other times collectively as the “lock systems 12.”

The lock systems 12 are electrically controlled to move, or at least be allowed to move, between the locked and unlocked positions. In the depicted embodiment, for example, the lock systems 12 are electromagnetic locks with the base 18 provided by an electromagnet and the locking member 22 provided by an armature plate or bar. For example, the upload lock systems 12a securing the hatch lids 80 can include conventional 1200 lb magnetic locks and the download lock systems 12b securing the box lids 74 can includes conventional 600 lb magnetic locks. Such conventional magnetic locks can be modified for use in the lock systems 12 by bypassing their onboard relay systems and customizing the mounting. Such conventional magnetic locks are commercially available from Armor Lock & Safe Co., Inc. (Tucker, Ga.). In typical embodiments, the electromagnetic locks are “fail-secure” type mag-locks that include each a permanent magnet in the base 18 that is used to secure the lock in the locked position and with power supplied to the electromagnet to cancel out the permanent magnet to unlock the lock, so that the lock remains securely locked if power is lost/cut and with power to the electromagnet required to open it. The electromagnet base 18 can be mounted to the tanker 90 by welding, brackets, straps, or other conventional mounting techniques. A tamper switch can be mounted between the tanker 90 and the electromagnetic base 18 and operably connected to the programmed controller of the control unit so that the lock 12 is secured in the locked position in the event tampering is detected.

For the upload lock system 12a depicted in FIGS. 2-8, the electromagnet base 18 is mounted to the tanker 90 adjacent the upload assembly 84 and the armature lock 22 includes a lock arm 20 extending therefrom. In the locked position, the lock arm 20 is positioned extending over and adjacent the hatch lid 80 so that the lid is locked in the closed position (and thus cannot be pivoted open to access the fuel in the tanker 90) due to a magnetic attractive force exerted on the armature lock 22 by the electromagnet base 18. And in the unlocked position, with the magnetic attractive force turned off, the lock arm 20 is moved so that it is not over and adjacent the hatch lid 80 so that the lid can now be pivoted open to upload fuel into the tanker 90 through the hatch opening 82. In the depicted embodiment, the armature lock 20 is pivotally mounted to the electromagnet base 18, and thus the lock arm 20 (which extends from the armature-plate lock) pivots relative to the electromagnet base 18 between the locked and unlocked positions. In alternative embodiments, the lock arm swivels or otherwise moves relative to the electromagnet base, or is completely removable from it.

In typical embodiments, the electromagnet base 18 and the armature lock 22 are a commercially available electromagnet lock that is a separately provided component from the locking arm 20. And the locking arm 20 extends from a lock body 24 that is mounted to the armature lock 22. The lock body 24 can have a cylindrical (as depicted) or other regular or irregular shape selected such that it tends to include slippage with any conventional tool/device that might be used to try gaining traction with the body in attempts to pry the lock 12a to the open position or detach the body from the lock. In this way, the lock system 12a can include a conventional electromagnetic lock component (with an electromagnet base 18 and an armature plate lock 22) sourced in one location, while the locking arm and body 20 and 24 component is sourced in another location. Then the two components can be easily assembled together for use, and the locking arm and body 20 and 24 component can be removed from one of the armature-plate locks 22 on one tanker 90 and relocated to the armature-plate lock of another tanker if desired. The locking body 24 is typically mounted to the armature-plate lock 22 by welding, though this mounting can be by bolts, brackets, straps, or other conventional mounting or fastening techniques. For example, the locking body 24 can be coupled to the armature-plate lock 22 such that, to access the mounting/fasteners to decouple and remove it, the lock system 12a has to be in the unlocked position, so the locking arm 20 cannot be easily removed by thieves to steal the fuel in the tanker 90. Alternatively, the lock arm 20 can extend directly from the armature-plate lock 22, with the base electromagnet 18, the lock arm, and the armature plate provided as a single integral unit, and without including the locking body 24.

In addition, the lock arm 20 can have an angle, bend, or curve so that it is at a close-enough distance from the hatch lid 80 when in the locked position to prevent accessing the fuel in the tanker 90, as depicted. In typical commercial embodiments, the locking arm 20 extends longitudinally (horizontally) beyond the electromagnet base 18 by about eighteen inches, and the locking body 24 is about six inches laterally wider (horizontally) than the electromagnet base. In addition, the locking arm 20 and the locking body 24 are typically made of high-strength steel or other material, and have large-enough widths, such that they can withstand high destructive forces in the event thieves attempt to induce a structural failure to remove the locking arm 20 from the locked position.

For the download lock system 12b depicted in FIGS. 2 and 9-11, the electromagnet base 18 is mounted within and to the download box 76 of the download assembly 86, for example within the box opening 75 and on the inner surface the box bottom wall. And the armature-plate lock 22 is mounted to the box lid 74 in a position aligned with the electromagnet base 18 when the lid is in the closed position. In the locked position, the box lid 74 is in the closed position so that the armature-lock plate 22 is adjacent the electromagnet base 18, which exerts a magnetic attractive force on the armature-plate lock that secures the box lid 74 in the closed position (so the valved pipes 78 in the download box cannot be accessed to access the fuel in the tanker 90). And in the unlocked position, with the magnetic attractive force turned off, the box lid 74 is free to be swung to the open position to download fuel from the tanker 90 through the valved pipes 78. In this embodiment, the lock 12b functions similarly to a conventional electromagnetic lock for a door in a building, with the electromagnet and the armature plate provided as two components that are not pivotally or otherwise mechanically coupled together.

In other embodiments, the lock systems 12 include electric motors that drive lock arms between the locked and unlocked positions, solenoids or other electric actuators in which the lock member is or extends from an electrically driven plunger of the actuator, electrically controlled piston-cylinders or other fluid-powered actuators in which the lock member is or extends from the piston, or other electrically controlled and/or operated lock systems.

The control unit 14 delivers power to the lock systems 12 and communicates with them to turn the electromagnets 18 on and off in response to lock and unlock signals received from the workstation 92 using the computer program 16 so that the lock systems can be secured in the locked positions and freed to move to the unlocked positions, respectively. In embodiments in which the control unit 14 and the lock systems 12 are separate components, such as that depicted, power and communications wiring 26 is routed from the control unit to each of the lock systems. In addition, typical embodiments include power wiring 28 routed to the control unit 14 from the electrical system of the vehicle. Such wiring 26 and 28 can be routed through rigid steel conduit securely coupled to the tanker 90 to prevent it from being easily cut by would-be thieves. In typical embodiments, the wiring 26 and 28 is provided by multi-strand shielded cable with failure circuits that create an open loop if cut so that the lock 12 is thereby secured in the locked position.

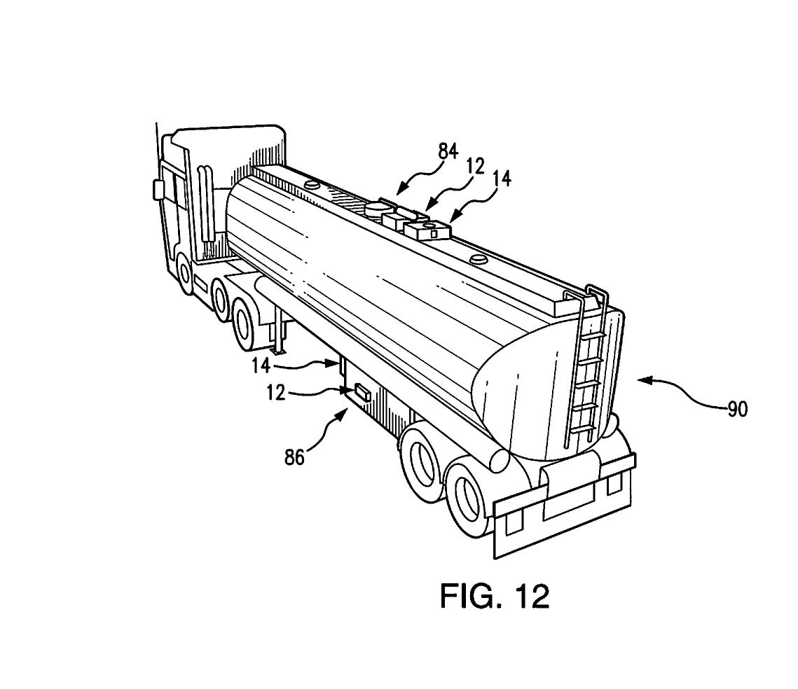

Referring with particularity to FIGS. 12-14, the control unit 14 as such includes a communications device 30, an antenna 32, at least one switching device 34, a programmed controller (not shown), and one or more back-up power supplies, with these components typically all contained within or connected to a housing 36 and operationally configured and connected in a conventional manner. In the depicted embodiment, the communications device 30 is a satellite communications device that communicates with the remote computer program 16 via the antenna 32, the satellite system 98, the gateway 97, and the communications network 96. These communications include lock and unlock signals that toggle the switching device 34 to turn the electromagnets 18 on and off, respectively, based on lock and unlock inputs, respectively, entered into and received from the workstation 92. In the depicted embodiment, for example, the satellite communications device 30 is provided by a modem that communicates with the IRIDIUM satellite constellation. Suitable IRIDIUM modems with built-in GPS transceivers are commercially available from NAL Research Corporation of Manassas, Va. (e.g., model 9602-LP). With this modem, the system 10 has a GPS sensitivity of about −160 dBm. The antenna 32 can be of a conventional IRIDIUM/GPS type such as that commercially available from NAL Research Corporation of Manassas, Va.

The switching device 34 can be provided by a relay, for example, a 5V relay such as an electronic brick −5V relay module (digital) of the type commercially available from numerous manufacturers. In embodiments in which each lock device 12 has a dedicated control unit 14, such as that depicted, each such control unit has one switch device 34 for its respective lock device. In other embodiments in which one control unit 14 operates a plurality of the lock devices 12, the control unit includes a plurality of the switching devices 34 so that each of the lock devices is controlled by a corresponding one of the switching devices 34. And in embodiments in which the area of use is covered by the communications network 96 and thus the satellite system 98 is not needed or used, the communications device can be provided by a conventional transceiver that communicates with the remote computer program 16 via the antenna 32 and the communications network 96. The control unit 14 of typical embodiments is designed to operate on a various communications networks 96 including the Internet, cellular networks, WiFi networks, WANs, and the like.

The back-up power supply provide powers to the control unit 14 in the event the power line 28 from the vehicle electrical system is cut or the vehicle is otherwise temporarily unpowered (e.g., by removing or discharging the vehicle battery). In the depicted embodiment, the back-up power supply includes a rechargeable battery pack 38 of a conventional type (such as four 12V deep-cycle rechargeable batteries) and a solar panel 40 of a conventional type (such as a low-profile solar device to provide solar-generated power). A suitable solar panel 40 is that commercially available under the brand SOLARFLAT 5 from Brunton Outdoor Group of Riverton, Wyo. The solar panel 40 can be mounted to the housing 36 or formed as a part of it. Additionally or alternatively, the back-up power supply can include a wind-generated power device such as a small low-profile 12V generator with a wind impeller (e.g., a worm drive enclosed in a tube) that mounts to the control unit housing 36.

A keypad 42 can be provided, for example mounted to the housing 36, to permit local operation to toggle the switching device 34 to turn the electromagnets 18 on and off, if desired (e.g., for use by authorizes users upon directly entering a passcode). In addition, a biometric scanner (e.g., a fingerprint or retinal reader) can be provided for reading a biometric feature (e.g., a fingerprint or retina) to authenticate a user in lieu of authenticate by inputting a passcode. The housing 36 can be of a conventional type for high-security environments such as a conventional NEMA enclosure of the type commercially available from numerous manufacturers. The housing 36 typically includes a locking door and is mounted to the tanker 90 by welding, bolts, brackets, straps, magnetic locks, or other conventional mounting or fastening techniques. The control unit housing 36 can be a fixedly attached to the tanker with a tamper switch mounted underneath its base and operably connected to the programmed controller so that the lock 12 is secured in the locked position in the event tampering is detected.

With this design, the control unit 14 can function with a standby current of less than 65 μA to provide for ultra-low power consumption. It can send standard or 256-bit AES encrypted tracking reports to the computer program 16 for accessing by the workstation 92. The control unit 14 can be designed to operate at a wide input voltage range for example from 5VDC to 32VDC. The control unit 14 can include two RS232 level I/Os for sensor interfaces and seven TTL/CMOS level I/Os for sensor interfaces. The control unit 14 can include an internal motion sensor positioned within the housing 36 and/or a plunger switch mounted on the bottom of the housing that sends a notice to the workstation 92 via the computer program 16 if the control unit is tampered with. And a “911” button device 44 can be operably connected to the control unit 14 and mounted in the cab of the vehicle so the driver can send a notice to the workstation 92 via the computer program 16 if the tanker is threatened or another emergency situation arises.

The computer program 16 is designed to provide for communication with the communications device 30 of the control unit 14 and to be accessed remotely by an authorized user of the workstation 92. The computer program 16 of typical embodiments is designed to operate on a various communications networks 96 including the Internet, cellular networks, WiFi networks, WANs, and the like. The computer program 16 typically includes standard features such as for registering authorized users, logging in using user names and passcodes, and the like. Such standard features are conventional, commercially available, and within the knowledge of persons of ordinary skill in the art, and as such are not described in detail herein.

In addition, the computer program 16 includes a locking component 48 that the users access using the workstations 96 to selectively lock and unlock the lock system. The locking component 48 is designed so that the system 10 provides for near real-time locking control of container assets 90 through the use of state-of-the-art IRIDIUM technology. The lock systems 12 are secured in the locked position though over-the-air activation by remote operators using the workstations 96 to access the locking component 48. In this way, the system 10 prevents pilferage of the fuel by denying access to an unauthorized party. The lock systems 12 can be released from the locked position (so they can be moved to the unlocked position), upon arrival of the tanker 90, by an authorized user accessing the workstation and sending a signal to the control unit 14 (or by allowing an authorized field operator to key in an access code). The anti-pilferage feature of the system 10 thus provides the ability to lock the shipment containers 90 while in transit and unlock them upon arrival at their destination. Once the lock systems 12 are unlocked and the fuel is downloaded from the tanker 90, the lock systems 12 can be relocked for use securing additional shipments for continued over-watch and control.

In typical embodiments, the locking component 48 of the computer program 16 includes a GUI feature that displays one or more control screens on the workstation 92 with inputs (e.g., click-on buttons) for authorized users to input lock and unlock commands to control the locks 12. For example, the control screens can include inputs for lock and unlock commands to control the locks 12 on a plurality of the tankers 90 that are in use in the field at any given time. Thus, one control screen can include a list of all of the tankers 90 that are equipped with the locks 12 and tanker status indicators to show whether each one of those tankers is in use transporting fuel at that particular time. This tanker list or a related screen can include mission (i.e., load or trip) fields that identify the routes the respective tankers 90 are on, for example by a brief description, a route number, or the like. A map-it feature can be included that when clicked displays a map marked with the route of the selected tanker 90. The mission fields or a related screen can include additional mission information such as start time, completion time, duration, distance, fuel type, fuel volume, driver, and the like. This tanker list or a related screen can also include a list of future and past missions for each tanker 90 along with information about them such as date, start time, completion time, duration, distance, fuel type, fuel volume, driver, and the like. The locking component 48 can also include a set-up feature that permits authorized users to input and edit the mission information, which is then saved on the storage device of the server 94. In some embodiments, the mission information can be uploaded from a scheduling system that the locking component 48 syncs up with.

And this tanker list or a related screen can include lock ID fields identifying each of the locks 12 on a given tanker 90 and respective lock status fields indicating the locked or unlocked status of each of the locks on that tanker. The inputs for the lock and unlock commands to control the locks 12 on the tankers 90 can be located adjacent the respective lock status fields, displayed on related screens, or integrally provided with the respective lock status fields (e.g., clicking on a status indicator toggles it between locked and unlocked indicia and also sends lock and unlock signals to control the position of the respective lock).

Furthermore, a tracking feature 46 is typically included as a component of the computer program 16, though this can be eliminated in some embodiments and in other embodiments provided as a stand-alone program stored on a separate server. The tracking component 46 can be provided by commercially available software such as that available from NAL Research Corporation of Manassas, Va. The tracking component 46 communicates with the control unit 14 and generates location (e.g., GPS) reports identifying the locations of the tankers 90 at pre-programmed intervals ranging for example from once every four seconds to once every seven days. The GPS report interval can be changed remotely from the workstation 92 while the locks 12 and controls 14 are on tankers 90 in the field.

The tracking component 46 is typically designed so that the system 10 provides for near real-time tracking of the tankers 90 for example through the use of state-of-the-art IRIDIUM technology. Such a tracking component 46 includes a geospatial interface that gives authorized users the ability to remotely track the tankers 90 in the field. The geospatial interface can be web-based and of a conventional type such as that commercially available under the brand name GOGGLE EARTH ENTERPRISE from Google, Inc. This provides for enduring and flexible over-watch of the tankers 90 in the field, whether static or mobile. The geospatial interface can include geo-fencing technology to provide the necessary proximity information, thus allowing increased battery life and transmit management. The geospatial interface preferably functions to display on a screen of the workstation 92 a map with the locations of the control units 14 as proxies for the tankers 90, along with identifiers of the tankers along with mission information fields displaying load data, vehicle and personnel information, and the like. The fields for each tanker 90 can be customizable by the operations center as needed and can be set according to daily needs. In addition, the tracking component 46 accommodates notification requirements for maintaining logs and date/time stamp accountability of delivery and pending departure for the next location. This capability allows the shipper the situational awareness and accountability of the tankers 90 in the area of operations from any computer or device workstation 92 with an Internet connection.

In some embodiments the tracking and locking components 46 and 48 are separate modules and in other embodiments they are integrated into a single module. Thus, in embodiments having the integrated tracking and locking module, the GUI feature of the locking component 48 is the same element as the geospatial interface of the tracking component 46, the mission information fields are the same, etc.

In other aspects of the invention, there are provided anti-theft methods of securing fuel in mobile containers such as tankers, which methods can be implemented using the systems described herein or other anti-theft systems. In one aspect, a method includes entering inputs into a computer program, using a workstation, to remotely control at least one control unit on a tanker that in turn controls at least one lock to move between locked and unlocked positions. And in another aspect, a method includes receiving lock and unlock inputs from a workstation and in response sending lock and unlock signals via a communications network to at least one remotely located control unit on a tanker that in turn controls at least one lock to move between locked and unlocked positions. In the locked position, the locks secure closed the upload and/or download assemblies of the tanker, and in the unlocked position they do not.

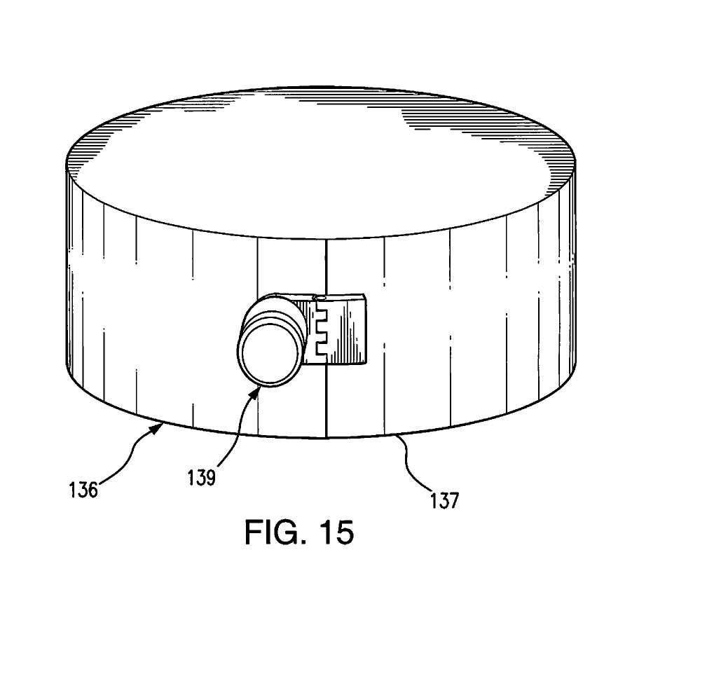

FIGS. 15-16 show a housing 136 of a control unit according to a first alternative embodiment. The alternative control-unit housing 136 is substantially similar to that of the first embodiment, except as noted herein.

The housing 136 has a door 137 that moves (e.g., hingedly pivots) between a closed position (FIG. 15) securing the control components (not shown) therein and an open position (FIG. 16) for accessing the control components for maintenance and adjustment. The housing 136 is secured in the closed position by a high-security lock 139 of a conventional type known in the art. The housing 136 is disc-shaped for high strength to withstand impacts and other tampering. The antenna (not shown) and solar panel (not shown) control components are mounted to the exterior of the housing 136, with their power and control wires (not shown) routed into the housing through a hole (not shown) drilled otherwise formed in the housing. The antenna is provided by an aircraft-type antenna in some embodiments.

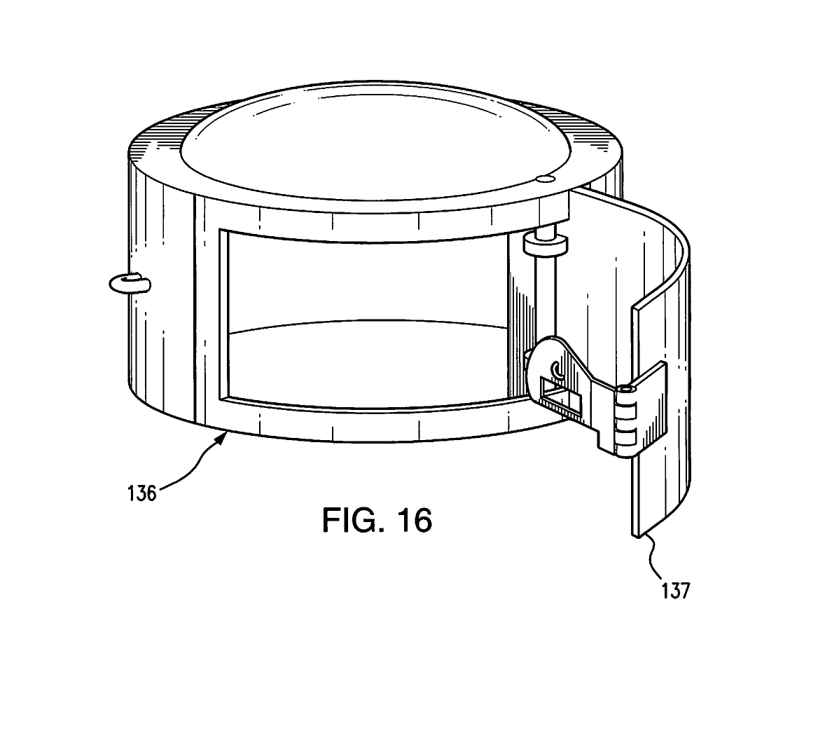

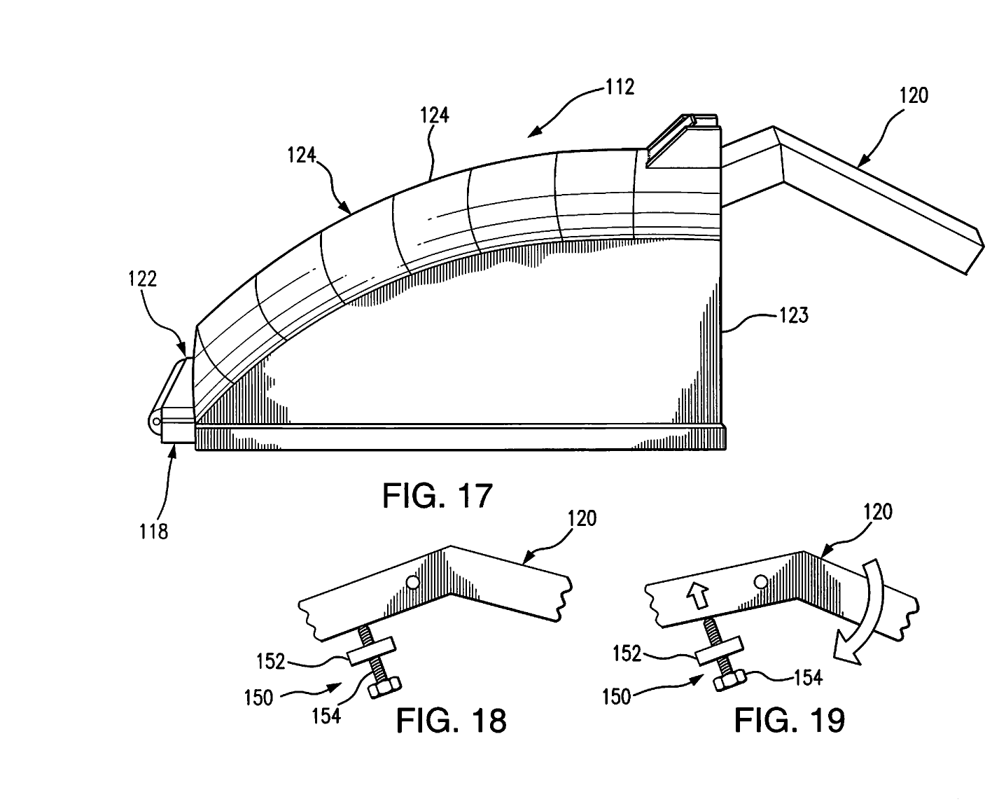

FIGS. 17-19 show a lock 112 according to the first alternative embodiment, with the lock shown in the locked position. The alternative lock 112 is substantially similar to that of the first embodiment, except as noted herein.

The lock includes a modified body 124 that is mounted to the armature lock 122 and that moves between the locked and unlocked positions relative to the electromagnet base 118. The modified body 124 is sometimes referred to as an “armadillo” lock body due to its generally similar appearance to the animal of the same name. In particular, the lock body 124 of the depicted embodiment includes two spaced apart sides (e.g., plates) 123 and a series of curved ribs (e.g., panels) 125 extending between and mounted to (e.g., by welding) top portions of the sides to form a shell enclosure whose shape and construction is very robust for high strength to withstand impacts and other tampering.

Within the enclosure is a mechanism 150 that is operable to adjust the position of the lock arm 112 relative to the tanker hatch lid (not shown). The adjustment mechanism 150 includes a mounting member 152 and an adjustment element 154. In the depicted embodiment, for example, the mounting member 152 is provided by a mounting bracket and the adjustment element 154 is provided by a set bolt extending through a threaded hole in the mounting member. The lock arm 112 is pivotally mounted to the lock body 124 and a portion of the lock arm extends into the shell enclosure of the lock body 124. The mounting bracket 152 and the adjustment set bolt 154 are positioned within the shell enclosure of the lock body 124 so that a positioning end of the set bolt engages the internal portion of the lock arm 112 to secure the lock arm from pivoting any farther away from the hatch lid when in the locked position. In this way, the set bolt 154 can be rotated relative to the mounting bracket 152 to advance the set-bolt positioning end against the internal portion of the lock arm 112, thereby limiting the pivoting motion of the lock arm away from to the hatch lid (see FIGS. 18-19). As such, the adjustment mechanism 150 provides additional security allowing custom fit of the lock 112 per application so that the lock arm can be tensioned against the hatch lid to prevent opening the hatch lid even a little bit to insert a thin fuel-siphoning device.

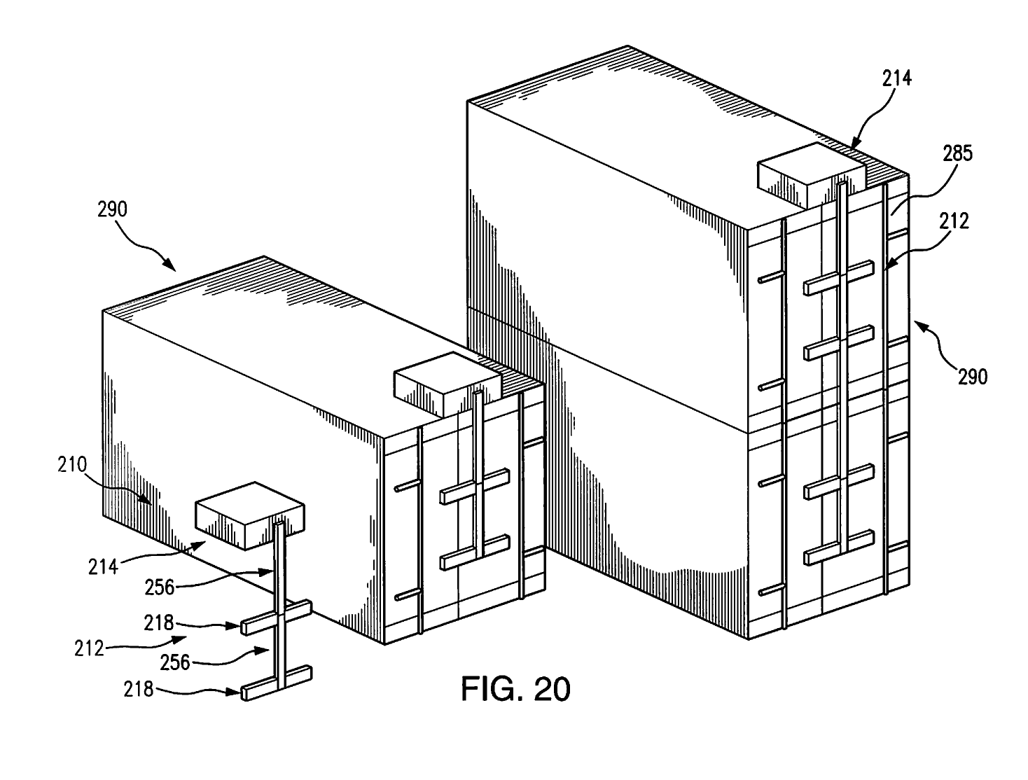

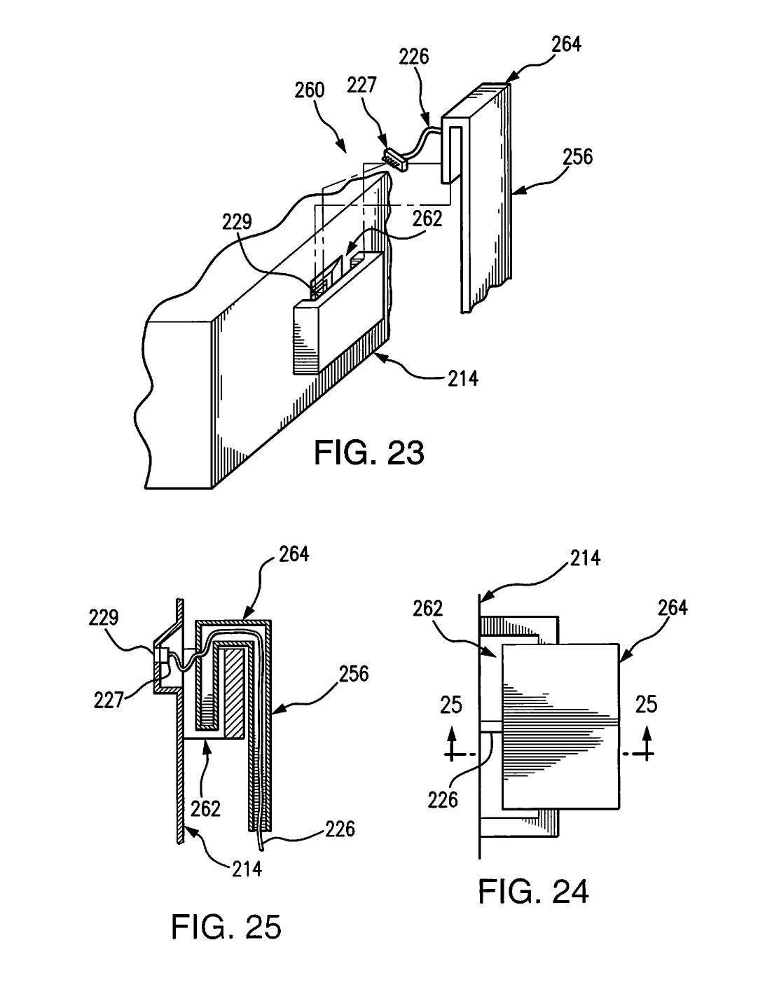

FIGS. 20-25 show an anti-theft system 210 according to a second example embodiment of the invention. The anti-theft system 210 is used in conjunction with the same system components (e.g., a communications network, a server, and at least one workstation) as described above with respect to the first embodiment. And the anti-theft system 210 includes the same major components (e.g., one or more lock systems 212, at least one electronic control unit 214, and a computer program (not shown)) as described above with respect to the first embodiment.

In this embodiment, however the lock systems 212 and the control systems 214 are adapted for use in securing cargo in dry containers 290 such as intermodal Conex or MilVan shipping/trucking containers. Such intermodal dry containers 290 have two rear doors 285 that cooperatively form both the upload assembly and the download assembly (the “load assembly”), that is, the stored/transported goods are uploaded and downloaded through those same two rear doors.

The control unit 214 removably mounts to the top side of the container 290. In typical embodiments, for example, the housing 236 of the control unit 214 mounts to the container 290 with an electromagnetic lock, with an electromagnet mounted to or included in the housing and with an aligned armature plate mounted to the container (e.g., by welding). In such embodiments, the control unit 214 and the computer program are modified to provide for locking and unlocking the control housing mounting lock to selectively secure the control housing to the container during transit and then quickly and easily remove the control unit 214 afterwards. In addition, the control units 214 can include power connectors that permit a plurality of them to be electrically connected together in a daisy chain for charging when not in use.

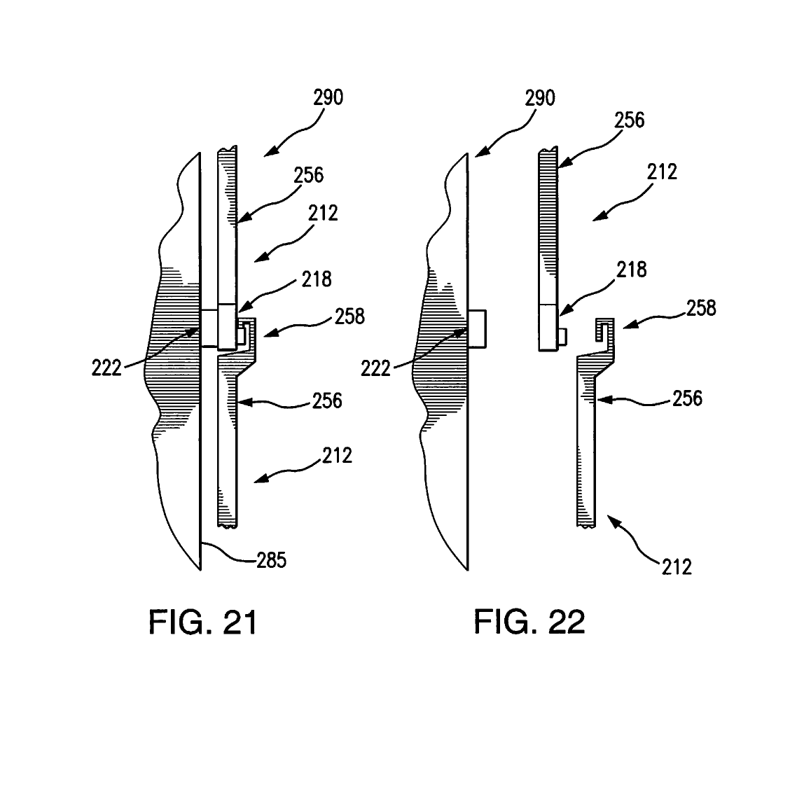

The lock 212 includes at least one base and at least one lock member that move relative to each other between locked and unlocked positions. In typical embodiments, the locks are provided by conventional electromagnetic locks (e.g., 600 lb or 1,200 lb), though in other embodiments other types of locks can be used, as described herein with respect to the first embodiment. In the depicted embodiment, for example, the locks 212 include two laterally extending electromagnet bases 218 connected to the control unit 214 by an upright connecting member 256, with the resulting lock assembly having the general shape of an inverted letter “T.” Only one or more than two electromagnet bases 218 can be provided for each lock 212, and the bases can be angled from horizontal if desired. An armature-plate lock 222 is mounted (e.g., welded) to one of the container doors 285 in a position that aligns with a respective one of the electromagnet bases 218 when positioned for use. The connecting member 256 is typically provided by a structural member (e.g., a hollow bar or tube) that supports the electromagnet bases 218 in suspension and by which the power/control wiring 226 is run back to the control unit 214. In other embodiments, the connecting member does not support the electromagnet bases but merely provides for routing the control/power wires back to the control unit. When the locks 212 are in the locked position (FIGS. 20-21) with the electromagnet base 218 and the armature-plate lock 222 secured together, the doors 285 of the load assembly cannot be opened. And when the locks 212 are in the unlocked position (FIG. 22) with the electromagnet base 218 and the armature-plate lock 222 disengaged and separated from each other, the doors 285 of the load assembly can be opened to upload or download the cargo.

Multiple lock assemblies 212 can be modularly connected together for operation by a single control unit 214, with the multiple locks used for one container 290 and/or with the multiple locks securing multiple containers. This modular coupling 258 permits any number of the locks 212 to be structurally and electrically connected together in a daisy chain, as may be desired for a given application. This modular coupling 258 can be similar to the modular coupling 260 between the control-proximal lock 212 and the control unit 214, which will now be described.

The modular coupling 260 provides for removably and operably coupling the control-proximal lock 212 to the control unit 214 so that the locks can be quickly and easily installed for use and removed afterward, with the locks supported in suspension during use. In the depicted embodiment, for example, the modular coupling 260 includes an opening (e.g., a slot or channel formed by a bracket) 262 formed by the control housing 236 that removably receives a hook (e.g., a tab or tongue extension) 264 formed on an upper portion of the connecting member 256. When the locks 212 are locked to the doors 285, the connecting member 256 cannot be moved, so the hook 264 engaging the slot 262 helps retain the control unit 214 in place on the container 290. In other embodiments, the locks are pivotally and operably coupled to the control unit so that the locks can be displaced from positions where they block the load assembly doors 285 from being opened.

In addition, the modular coupling 260 provides for removably connecting the power/control wiring 226 between the lock 212 and the control unit 214. In the depicted embodiment, for example, the power/control wiring 226 includes a connector (e.g., a male jack or plug) 227 that electrically connects to a cooperating connector (e.g., a female receptacle) 229 in the control housing 236. The control-housing connector 229 can be positioned within a well formed in the control housing 236 and at least partially within the bracket opening 262 to make it more difficult for thieves to disconnect the power to the locks 212.

In other embodiments, the system can be adapted for use on stationary container of a supply of a fluid, material, or other object. For example, the system can be used to remotely control access to unattended tanks of fuel, water, etc., that are spread out over an area.

Accordingly, the anti-theft systems and methods can be used to give the shipper numerous control measures to ensure mission success through tracking, accountability, and a state of the art anti-pilferage capability by preventing unauthorized access to the cargo. The anti-theft system and method thereby provide the shipper peace of mind as well as the overall control measure for accountability through geospatial location data paired with a user-friendly web interface. The anti-theft system and method provide the shipper access control to the shipment while ensuring control and tracking of each load. And in many embodiments the locks and control unit and locks can be mounted to a container in fifteen minutes or less, and later removed within the same timeframe, thereby providing for quick and easy installation and removal.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be unnecessarily limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

1. A system for preventing access to a supply in a container through a load assembly thereof, the system used by an authorized user using a workstation and a server both in communication via a communications network, the system comprising:
a lock system that mounts to the container on or adjacent the load assembly, wherein the lock system includes a base and a lock element that moves relative to the base between locked and unlock positions, in the locked position the lock system secures the load assembly in a closed position, and in the unlocked position the lock system permits movement of the load assembly to an open position;
a control unit that is operably connected to the lock system and that communicates with the lock system to selectively secure the lock system in the locked and unlocked positions, the control unit including a communications device and a switching device; and
a computer program that communicates with the communications device of the control unit via the communication network, is stored on the server and accessed via the communication network, and is operated by the workstation, the program including a locking component that the authorized user accesses using the workstation to selectively enter lock and unlock commands to remotely control the switching device to in turn manipulate the lock system between the locked and unlocked positions.

2. A The system of claim 1, wherein the lock system comprises an electromagnetic lock with the base comprising an electromagnet and the lock element comprising an armature.

3. The system of claim 2, wherein the container is a tanker and the load assembly comprises an upload assembly including a hatch with a lid, the electromagnetic base is mounted to the container laterally adjacent the hatch, the armature lock element pivots relative to the electromagnetic base, and the armature lock element includes a lock arm extending therefrom and positioned over the hatch lid in the locked position and displaced therefrom in the unlocked position.

4. The system of claim 3, wherein the armature lock element further comprises a lock body from which the lock arm extends.

5. The system of claim 2, wherein the container is a tanker and the load assembly comprises a download assembly including a box with a lid, the electromagnetic base is mounted to the container within the box, and the armature lock element is mounted to the box lid in alignment with the electromagnetic base when the box lid is in the closed position.

6. The system of claim 2, wherein the container is a dry container and the load assembly comprises at least one door, the electromagnetic base is mounted to a connecting member that mounts to the control unit, and the armature lock element is mounted to the door in alignment with the electromagnetic base when the door is in the closed position.

7. The system of claim 6, wherein the electromagnetic base is suspended from the control unit by the connecting member.

8. The system of claim 7, wherein multiple ones of the electromagnetic base and the connecting member are modularly connected together.

9. The system of claim 1, wherein the communications network includes a satellite network, and wherein the communications device of the control unit comprises a satellite communications device that communicates with the computer program via the satellite network.

10. The system of claim 1, wherein the locking component displays to the workstation a list including the container and any other container in use, as well as a mission field including mission information related to the container.

11. The system of claim 1, wherein the program further comprises a tracking component configured to remotely monitor a location of the container.

12. A method of preventing access to the supply using the system of claim 1, comprising:
accessing the computer program via the communications network by using the workstation;
entering the lock and unlock commands to remotely control the control unit to selectively lock and unlock the lock system.

13. A system for preventing theft of a cargo in a mobile container through a load assembly thereof, the system used by an authorized user using a workstation and a server both in communication via a communications network, the system comprising:
at least one lock system that mounts to the container on or adjacent the load assembly, wherein the lock system includes a base and a lock element that moves relative to the base between locked and unlock positions, in the locked position the lock system secures the load assembly in a closed position, in the unlocked position the lock system permits movement of the load assembly to an open position, wherein the lock system comprises an electromagnetic lock with the base comprising an electromagnet and the lock element comprising an armature;
a control unit that is operably connected to the lock system and that communicates with the lock system to selectively secure the lock system in the locked and unlocked positions, the control unit including an antenna, a transceiver, and a switching device; and
a computer program that communicates with the transceiver of the control unit via the communications network, is remotely stored on the server and accessed via the communication network, and is remotely operated by the workstation, the program including a locking component that the authorized user accesses using the workstation to selectively enter lock and unlock commands to remotely control the switching device to in turn manipulate the lock system between the locked and unlocked positions, and the program including a tracking component configured to remotely monitor a location of the container.

14. The system of claim 13, wherein the container is a tanker and the load assembly comprises an upload assembly and a download assembly, the upload assembly including a hatch with a lid, and the download assembly including a box with a lid, wherein the at least one lock system comprises an upload lock and a download lock, wherein the electromagnetic base of the upload lock is mounted to the container laterally adjacent the hatch, the armature lock element of the upload lock pivots relative to the electromagnetic base, and the upload armature lock element includes a lock arm extending therefrom and positioned over the hatch lid in the locked position and displaced therefrom in the unlocked position, and wherein the electromagnetic base of the download lock is mounted to the container within the box, and the armature lock element of the download lock is mounted to the box lid in alignment with the electromagnetic base when the box lid is in the closed position.

15. The system of claim 14, wherein the armature lock element further comprises a lock body from which the lock arm extends, the lock body forming a shell enclosure and including an adjustment mechanism having a mounting element and a set screw that advances and retracts relative to the mounting element to engage and adjust the position of the locking arm.

16. The system of claim 13, wherein the container is a dry container and the load assembly comprises at least one door, the electromagnetic base is mounted to a connecting member that mounts to and is suspended from the control unit, and the armature lock element is mounted to the door in alignment with the electromagnetic base when the door is in the closed position.

17. The system of claim 16, wherein multiple ones of the electromagnetic base and the connecting member are modularly connected together.

18. The system of claim 13, wherein the communications network includes a satellite network, and wherein the transceiver of the control unit comprises a satellite transceiver that communicates with the computer program via the satellite network.

19. The system of claim 13, wherein the locking component displays to the workstation a list including the container and any other container in use, as well as a mission field including mission information related to the container.

20. A method of preventing access to the supply using the system of claim 13, comprising:
accessing the computer program via the communications network by using the workstation;
entering the lock and unlock commands to remotely control the control unit to selectively lock and unlock the lock system.

20. (canceled)
